(19) United States
(12) Patent Application Publication
(10) Pub. No.: US 2003/0181118 A1
(43) Pub. Date: Sep. 25, 2003

(54) One-way quick absorption and drying fabric

(76) Inventors: Kung Chan Ko, Seoul (KR); Sin Jung Park, Seoul (KR)

Correspondence Address: PARK & SUTTON LLP, 3255 WILSHIRE BLVD, SUITE 1110, LOS ANGELES, CA, 90010, US

(21) Appl. No.: 10/206,656

(22) Filed: Jul. 29, 2002

(30) Foreign Application Priority Data
Mar. 19, 2002 (KR) 2002-0014896

(51) Int. Cl. B32B 5/02; B32B 27/04; B32B 27/12; D03D 15/00; D03D 25/00; D04H 1/00; D04H 3/00; D04H 5/00; D04H 13/00; B32B 5/26; B32B 5/06

(52) U.S. Cl. 442/335; 442/337; 442/381; 442/389; 442/66; 442/67; 442/79; 442/118

(57) ABSTRACT

A one-way quick absorption and drying fabric is provided. The fabric has a back layer made of a hydrophobic yarn, and a surface layer made of a moisture absorbing yarn. The back layer pushes moisture and the surface layer absorbs moisture so that moisture is absorbed in one-way. The moisture absorbing yarn may be an irregular yarn having a irregular cross section that has three or more channels, a hydrophilic yarn such as cotton, rayon or wool having a moisture regain greater than about 8%, or a circular polyester or polyamide yarn that has been moisture absorption treated. The hydrophobic yarn has a moisture regain that is less than about 1% and may be made of polyolefin, polyester or polyamide. The yarn may also be water repellant finished.

### CLAIMING FOREIGN PRIORITY

The applicant claims and requests a foreign priority, through the Paris Convention for the Protection of Industry Property, based on a patent application filed in the Republic of Korea (South Korea) with the filing date of Mar. 19, 2002, with the application number 2002-0014896, by the applicants (See the Attached Declaration).

### BACKGROUND OF THE INVENTION

The present invention relates to a one-way absorption and drying fabric. More particularly, the invention relates to a fabric having two layers of different properties to provide the one-way absorption and drying feature.

Quick absorption and dry fabrics by prior art were knitted or woven with only irregular yarns. Irregular yarns are made such that they have irregular cross-sections. Prior art fabrics can eliminate sweat effectively when a wearer of clothes made from the fabrics do exercise. However, when it rains or when the clothes are contacted with water, the fabric absorbs water and transfers water to the back layer (a layer that contacts the skin of a wearer) faster than ordinary fabrics. Thus the fabric tends to wrap or stick to the skin and gives the wearer unpleasant feelings. Also, the quick absorption and dry fabric by prior art has the disadvantage that it absorbs and transfers dew to the skin faster than ordinary fabrics at night time mountain climbing, resulting in the problems of lowering body temperature and giving damp feeling to the wearers.

A method for providing a two-layer moisture absorbing fabric was suggested. The two-layer fabric were knitted or woven with divisional micro fiber made of polyester and polyamide, and normal polyester yarn. Then weight of the fabric was reduced by treating with NaOH. Though such fabric has better moisture absorbing performance than ordinary fabrics, it has a disadvantage that drying of absorbed moisture is slow since the moisture is trapped in the pores of the micro fiber. Also the circular cross-section of the yarn limits the moisture absorbing capability. Especially, since micro fibers have poor dyeability, the fabric is not suitable for sportswear, which requires good color fastness against washing and water.

### SUMMARY OF THE INVENTION

The present invention contrives to solve the disadvantages of prior art.

Therefore, an object of the invention is to provide a fabric that has one-way moisture absorption feature that provides selective moisture transfer.

Another object of the invention is to provide a fabric that exhausts sweat of a wearer who takes exercise to outside, but blocks moisture from outside to the skin of the wearer.

To achieve the above-described objects, the invention provides a one-way quick absorption and drying fabric that comprises a back layer made of a hydrophobic yarn, and a surface layer made of a moisture absorbing yarn. The back layer pushes moisture and the surface layer absorbs moisture so that moisture is absorbed in one-way.

In the first embodiment of the invention, the moisture absorbing yarn is an irregular yarn having a irregular cross section that has three or more channels. Preferably, the irregular yarn has four channels and the hydrophobic yarn has a moisture regain that is less than about 1%. More preferably, the moisture regain of the hydrophobic yarn is less than about 0.5%. Also, the density of the back layer is bigger than the density of the surface layer by more than about 110%. The hydrophobic yarn has a circular cross section and may be made of polyester or polyamide.

In the second embodiment of the invention, the moisture absorbing yarn is a hydrophilic yarn having a moisture regain greater than about 8%. The hydrophilic yarn may be made of cotton, rayon or wool. The hydrophobic yarn may be made of polyolefin, polyester, or polyamide, and the hydrophobic yarn is water repellent finished. The finishing is performed with a silicone water repelling agent or a fluoric water repelling agent.

In the third embodiment of the invention, the moisture absorbing yarn is made of a circular yarn that has been moisture absorption treated. The moisture absorbing yarn may be made of polyester or polyamide. The hydrophobic yarn may be made of polypropylene, or a polyester yarn or a polyamide yarn that is water repellant finished.

The advantages of the present invention are numerous in that: (1) clothing made of the fabric of the present invention provide a pleasant feeling even when it rains; (2) the fabric has a ultra fast moisture absorbing power using both the capillary tube phenomenon of the surface layer and the pushing power of the back layer; and (3) the fabric provides a selective one-way moisture absorbing and fast drying that blocks moisture from outside and exhausts sweat of a human body.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic cross-sectional view of a fabric according to the present invention;

FIG. 2 is a schematic cross-sectional view of a irregular yarn according to the present invention;

FIG. 3 is a schematic cross-sectional view of the fabric according to the first embodiment;

FIG. 4 is a schematic cross-sectional view of the fabric according to the second embodiment; and

FIG. 5 is a schematic cross-sectional view of the fabric according to the third embodiment.

### DETAILED DESCRIPTION OF THE PREFERRED EMBODIMENTS

The present invention provides a fabric that utilizes two forces exerted by its two layers. While the prior art depends on simple capillary tube phenomenon for moisture absorption, the present invention provides a two-layer fabric 10 having a back layer 12 made of a hydrophobic yarn, and a surface layer 14 made of a moisture absorbing yarn.

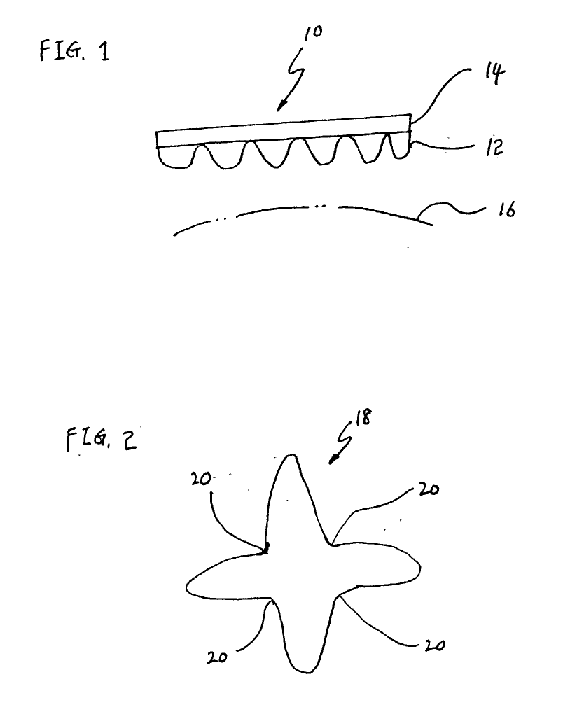

FIG. 1 shows that the fabric 10 is woven or knitted with the back layer 12 and the surface layer 14, and the back layer 12 is adjacent to the skin 16 of a wearer, and the surface layer 14 is exposed to the outside. Unlike the fabric of prior art that absorbs both the sweat from the skin and moisture from the outside when it rains, since the back layer 12 pushes the sweat from the skin 16 and the surface layer 14 absorbs the sweat, the sweat is quickly absorbed and dried, but moisture from the outside is pushed and blocked by the back layer 12 and cannot reach the skin 16.

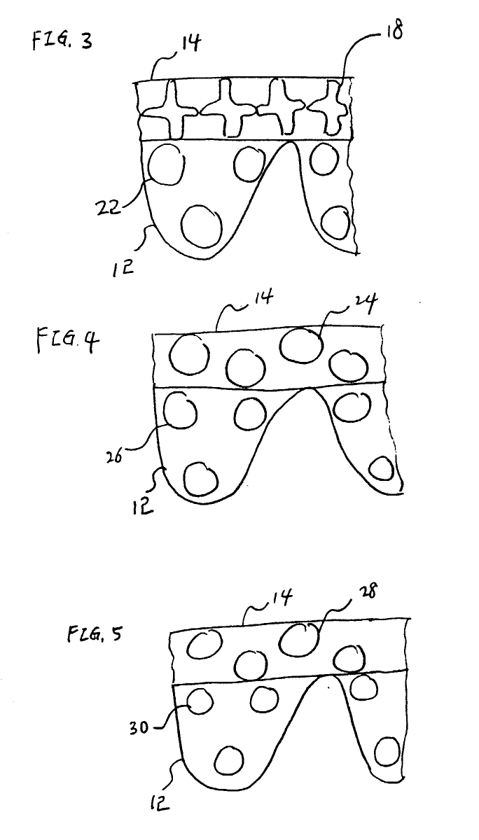

In the first embodiment of the invention shown in FIG. 3, the moisture absorbing yarn of the surface layer 14 is an irregular yarn 18 having a irregular cross section that has three or more channels 20. Preferably as shown in FIG. 2, the irregular yarn 18 has four channels 20. This irregular shape, and thus the channels 20 provide superior moisture absorbing capability. The irregular yarn 18 may be made of polyester or polyamide. The channels 20 of the irregular yarn 18 generate capillarity to move the sweat pushed by the back layer 12 to the surface layer 14. The large surface area of the irregular yarn 18 enables quick drying of the sweat.

The hydrophobic yarn 22 of the back layer 12 has a moisture regain that is less than about 1%. Preferably, the moisture regain is less than about 0.5%. This small value of moisture regain generates a pushing power of moisture and pushes sweat to the outside together with the moisture absorbing feature of the surface layer 14 at the portion that contacts the skin 16.

The density of the back layer 12 is bigger than the density of the surface layer 14 by more than about 110%. That is, the back layer 12 has a higher density and the surface layer 14 has a lower density. Since the density of the back layer 12 is higher than that of the surface layer 14, when moisture from the outside contacts the fabric, there is comparatively less tendency to move the moisture inside. Simultaneously, the pushing power exerted by the back layer 12 blocks the moisture that tries to penetrate inside.

On the other hand, when the sweat is exhausted from the skin 16, since the back layer 12 is denser than the surface layer 14, the sweat inside is quickly moved to the surface layer 14. The capillarity of the irregular yarn 18 creates a synergic effect together with the density difference. The fabric 10 of the present invention provides substantially enhanced moisture absorption and drying capability by this close cooperation of the pushing power of the high-density back layer 12, and the capillarity of the low-density surface layer 14. Further, the moisture absorption is one-way as explained above.

The hydrophobic yarn 22 has a circular cross section and may be made of polyester or polyamide.

In the second embodiment of the invention that is shown in FIG. 4, the moisture absorbing yarn of the surface layer 14 is a hydrophilic yarn 24 having moisture regain greater than about 8%. The hydrophilic yarn 24 may be made of cotton, rayon or wool.

The hydrophobic yarn 26 of the back layer 12 is made of polyolefin, polyester, or polyamide, and is water repellent finished with a silicone water repelling agent or a fluoric water repelling agent to have moisture regain less than 1%.

In the third embodiment of the invention, the moisture absorbing yarn is made of a circular yarn that has been moisture absorption treated. The moisture absorbing yarn may be made of polyester or polyamide. The hydrophobic yarn is made of polypropylene or a polyester yarn or a polyamide yarn that is water repellant finished.

The moisture absorption treatment is performed by padding the fabric with a moisture absorption treatment agent that has OH component at its terminal group. Since the agent cannot penetrate into the back layer 12, the yarns of which have been water repellant treated, the agent penetrates only into the surface layer 14 and gives moisture absorption property to the yarns of the surface layer 14. The treatment is done at the final setting (tenter) process after dying the fabric.

The fabric 10 of the present invention can be knitted or woven by an ordinary weaving machine that can supply the weft selectively, or a double circular knitting machine. For example, when the fabric is woven, the hydrophobic yarn 22 is supplied for the back layer 12, and the irregular yarn 18 is supplied for the surface layer 14, while keeping the density of the back layer 12 bigger than that of the surface layer 14 by more than 120%.

After the fabric 10 is woven, after-treatment such as anti-bacteria treatment may be done to give the fabric versatility. The fabric 10 may be used to make clothing, bedding, and towels, etc.

The moisture absorbing and drying capability of the fabric 10 was evaluated as below.

The absorbing speed (mm/10 minutes) was measured according to KSK 0815.5.27.1B. A specimen having a size of 3 cm in width and 20 cm in length was prepared, and the end of the specimen was immersed in water. The length that water rose along the specimen was measured.

The drying Speed (minutes) was measured according to KSK 0815.5.28.1. Under the standard state, a specimen of the fabric was wet with water by an amount same as the weight of the specimen. And the time required to dry the specimen completely was measured.

[Test 1]

A polyester irregular yarn having four channels and of 75 denier was supplied to the surface layer and a polyolefin yarn of 75 denier was supplied to the back layer with a 28 gauge double circular knitting machine. The amounts of the yarns supplied were controlled so that the density of the back layer is bigger than the density of the surface layer by 30%.

[Test 2]

A polyamide yarn having an irregular cross-section was supplied to the surface layer and a polyester yarn that had been yarn-dyed and water repellant treated was supplied to the back layer. The fabric was knitted to have the same structure as in Test 1.

[Comparison Test 1]

Polyester irregular yarns were supplied for both the surface layer and back layer. The fabric was knitted to have the same structure as in Test 1.

[Comparison Test 2]

Polyamide irregular yarns were supplied for both the surface layer and back layer. The fabric was knitted to have the same structure as in Test 1.

Table 1 shows the results for the tests.

TABLE 1
Test results for moisture absorption and drying

| | Absorbed Length (mm/10 min.) | | |
|---|---|---|---|
| | Wale direction | Course direction | Drying Speed (min.) |
| Test 1 | 190 | 180 | 15 |
| Test 2 | 185 | 170 | 20 |
| Comparison 1 | 110 | 95 | 100 |
| Comparison 2 | 115 | 100 | 110 |

The fabric of the present invention provides excellent moisture absorption property and fast drying speed, and blocks moisture from the outside. Therefore, the fabric is suitable for various sportswear and bedding. Also, the fabric of the present invention keeps its properties semi permanently since the features are implemented within the yarns and the structure of the fabric.

Although the invention has been described in considerable detail, other versions are possible by converting the aforementioned construction. Therefore, the scope of the invention shall not be limited by the specification specified above.

What is claimed is:

1. A one-way quick absorption and drying fabric comprising:
a) a back layer made of a hydrophobic yarn; and
b) a surface layer made of a moisture absorbing yarn;
wherein the back layer pushes moisture and the surface layer absorbs moisture so that moisture is absorbed in one-way.

2. The fabric of claim 1 wherein the moisture absorbing yarn is an irregular yarn having a irregular cross section that has three or more channels.

3. The fabric of claim 2 wherein the irregular yarn has four channels.

4. The fabric of claim 2 wherein the hydrophobic yarn has a moisture regain that is less than about 1%.

5. The fabric of claim 4 wherein the moisture regain is less than about 0.5%.

6. The fabric of claim 4 wherein the density of the back layer is bigger than the density of the surface layer by more than about 110%.

7. The fabric of claim 6 wherein the hydrophobic yarn has a circular cross section.

8. The fabric of claim 7 wherein the hydrophobic yarn is made of polyester or polyamide.

9. The fabric of claim 1 wherein the moisture absorbing yarn is a hydrophilic yarn having a moisture regain greater than about 8%.

10. The fabric of claim 9 wherein the hydrophilic yarn is made of cotton, rayon or wool.

11. The fabric of claim 10 wherein the hydrophobic yarn is made of polyolefin, polyester, or polyamide, and wherein the hydrophobic yarn is water repellent finished.

12. The fabric of claim 11 wherein the hydrophobic yarn is water repellent finished with a silicone water repelling agent or a fluoric water repelling agent.

13. The fabric of claim 12 wherein the hydrophobic yarn has a moisture regain that is less than about 1%.

14. The fabric of claim 1 wherein the moisture absorbing yarn is made of a circular yarn that has been moisture absorption treated.

15. The fabric of claim 14 wherein the moisture absorbing yarn is made of polyester or polyamide.

16. The fabric of claim 15 wherein the hydrophobic yarn is made of polypropylene.

17. The fabric of claim 15 wherein the hydrophobic yarn is made of a polyester yarn or a polyamide yarn that is water repellant finished.

18. The fabric of claim 16 wherein the hydrophobic yarn has a moisture regain that is less than about 1%.

19. The fabric of claim 17 wherein the hydrophobic yarn has a moisture regain that is less than about 1%.
